(19) United States
(12) Patent Application Publication
(10) Pub. No.: US 2023/0225256 A1
(43) Pub. Date: Jul. 20, 2023

(54) METHOD FOR REGULATING ILLUMINATION OF GROWING PLANTS, ELECTRONIC DEVICE, AND STORAGE MEDIA

(71) Applicant: Fulian Precision Electronics (Tianjin) Co., LTD., Tianjin (CN)

(72) Inventors: CHIA-EN LI, New Taipei (TW); MENG-PEI SUNG, New Taipei (TW); PO-HUI LU, New Taipei (TW)

(21) Appl. No.: 17/954,530

(22) Filed: Sep. 28, 2022

(30) Foreign Application Priority Data
Jan. 19, 2022 (CN) 202210059946.X

(51) Int. Cl. A01G 7/04; G06T 7/73; G06V 10/44; G06V 20/10

(52) U.S. Cl. CPC A01G 7/045; G06T 7/74; G06V 10/44; G06V 20/188; G06T 2207/30188

(57) ABSTRACT

A method for regulating illumination of plants, an electronic device, and a storage medium are disclosed. In the method, plant images are inputted into a growth calculation model to obtain a target growth parameter, the target growth parameter is analyzed according to a state shunt model to obtain a first physiological stage, a growth change value of the target plant is calculated according to target growth parameters, the first physiological stage is adjusted according to the growth change value to obtain a second physiological stage, a target illumination time corresponding to the second physiological stage is generated based on the target growth model, a target time period is generated according to the light regulation model and the target illumination time, the target time period is send to an illumination device to regulate illumination of the target plant.

### FIELD

The subject matter herein generally relates to image processing, in particular to a method for regulating illumination of growing plants, an electronic device, and a storage media.

### BACKGROUND

In production management of plants being grown, illumination of the plants is controlled by a single control manner and is not regulated according to physiological stages of the plants, which does not result in optimal growth of the plants. Moreover, due to cost of power consumption, a single control manner in a computer brings a high cost.

### BRIEF DESCRIPTION OF THE DRAWINGS

Implementations of the present technology will now be described, by way of embodiment, with reference to the attached figures.

FIG. 1 is a schematic diagram of an application environment of a method for regulating illumination of plants according to an embodiment of the present disclosure.

FIG. 2 is a flowchart of a method for regulating illumination of plants according to an embodiment of the present disclosure.

FIG. 3 is schematic diagram showing a coordinate system constructed in a method for regulating illumination of plants according to an embodiment of the present disclosure.

FIG. 4 is schematic diagram of an electronic device according to an embodiment of the present disclosure.

### DETAILED DESCRIPTION

In order to make objects, technical solutions, and advantages of present embodiments more comprehensible, the present embodiments are described in detail below with reference to drawings and specific embodiments.

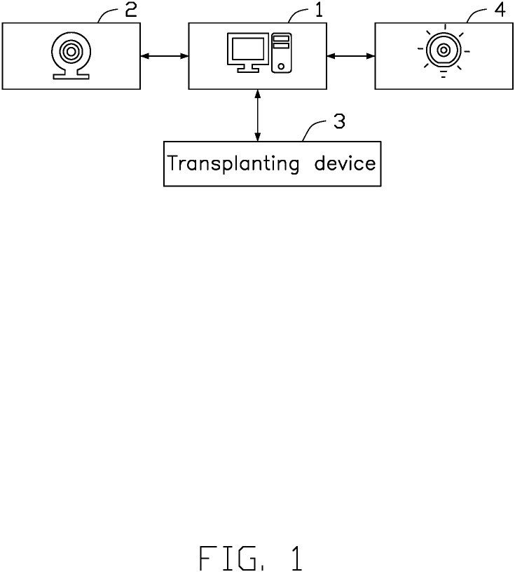

FIG. 1 is a schematic diagram of an application environment of a method for regulating illumination of plants according to an embodiment. The method can be applied to one or more electronic devices 1. The electronic devices 1 communicate with an imaging device 2, a transplanting device 3, and an illumination device 4. The imaging device 2 may be a camera or other devices having imaging capturing functions. For example, the image device 2 can capture images of plants (plant images) of target plants, the target plants may be lettuce and other vegetable plants. The transplanting device 3 may be any movable device which can be controlled to grasp, move, and put down items, such as a manipulator. The illumination device 4 can be any device that can illuminate items, such as an LED lamp.

The electronic device 1 can automatically perform numerical calculation and/or information processing according to an instruction configured or stored in advance, and hardware of the electronic device 1 includes, but is not limited to, a microprocessor, an Application Specific Integrated Circuit (ASIC), a Field-Programmable Gate Array (FPGA), a Digital Signal Processor (DSP), and an embedded device, etc.

The electronic device 1 can be any electronic product that can interact with a user, such as personal computers, tablet computers, smart phones, personal digital assistants (PDA), game machines, Internet Protocol Televisions (IPTV), and smart wearable devices, etc.

The electronic device 1 can also include a network device and/or a user device. The network device includes, but is not limited to, a single network server, a server group including a plurality of network servers, or a cloud computing including a plurality of hosts or network servers.

The electronic device can be connected to a network. The network can include, but is not limited to, the Internet, a wide region network, a metropolitan region network, a local region network, a virtual private network (VPN), and the like.

The electronic device 1, the imaging device 2, the transplanting device 3, and the illumination device 4 can be applied to a plant factory. The plant factory refers to a place where standardized planting and management of plants can be carried out. In the plant factory, different types of plants can be planted, such as vegetable plants and flowers.

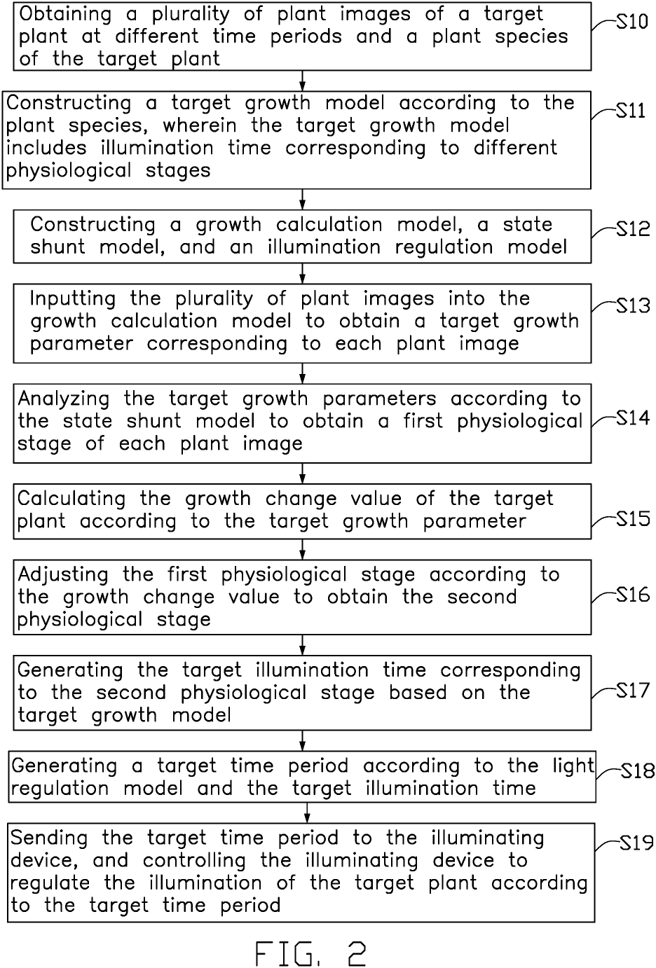

FIG. 2 is a flowchart of the method according to an embodiment. According to different requirements, an order of blocks in the flowchart may be changed, and some blocks may be deleted. The method is executed by an electronic device, such as the electronic device 1 shown in FIG. 1. The method begins at block S10.

At block S10, a plurality of plant images of a target plant at different time periods and a plant species of the target plant are obtained.

In at least one embodiment, the target plant refers to any one plant cultivated in the plant factory.

In at least one embodiment, the electronic device obtains a plurality of plant images of a target plant at different time periods by steps as follows.

The electronic device controls the imaging device to image the target plant at a preset time interval to obtain a plurality of plant images of the target plant. The preset time interval may include, but is not limited to, two hours or three hours.

In at least one embodiment, the electronic device obtains the plant species of the target plant from a preset database.

The plant species may be lettuce or other. For example, the electronic device controls the imaging device to image the target plant every three hours to obtain a plurality of plant images of the target plant.

At block S11, a target growth model is constructed according to the plant species, where the target growth model includes illumination times corresponding to different physiological stages.

In at least one embodiment, the target growth model refers to a model with a relationship between each physiological stage and the illumination time. The target growth model can be used to determine the illumination time according to the physiological stage of the target plant.

In at least one embodiment, the electronic device constructs the target growth model according to the plant species by steps as follows.

The electronic device obtains growth data of the target plant from the preset database according to the plant species, the growth data including a plurality of initial physiological stages and a plurality of initial illumination times, and the electronic device constructs the relationship between each initial physiological stage and each initial illumination time, thereby obtaining the target growth model.

The plurality of initial physiological stages refer to the different physiological states of the target plant. The plurality of initial physiological stages may be divided into multiple stages by several manners of division. In one embodiment, the initial physiological stages are divided according to different plant characteristics of the target plant in different time periods.

For example, when the plant species is lettuce, the plurality of initial physiological stages can be divided into germination period, seedling period, growing period, and harvest period according to a leaf size of the plant at different time periods. It is to be understood that the electronic device constructs the relationship between each initial physiological stage and each initial illumination time, determines the illumination time corresponding to the germination period as 15 hours, determines the illumination time corresponding to the seedling period as 13 hours, determines the initial illumination time corresponding to the growing period as 11 hours, and determines the initial illumination time corresponding to the harvest period as 10 hours.

By constructing the relationship between each initial physiological stage and each initial illumination time, the illumination time required by the target plant can be quickly determined according to the physiological stage.

At block S12, a growth calculation model, a state shunt model, and an illumination regulation model are constructed.

In at least one embodiment, the growth calculation model refers to a model that can calculate a value of growth change of the target plant.

In at least one embodiment, the state shunt model refers to a model that can determine a physiological state of the target plant.

In at least one embodiment, the illumination regulation model refers to a model that can determine an illumination time period according to the illumination time of the target plant.

In at least one embodiment, the electronic device constructs the growth calculation model based on a deep convolution neural network. The deep convolution neural network can be Resnet50, Alexnet, VGG16, etc.

In at least one embodiment, the electronic device constructs the state shunt model by steps as follows.

The electronic device obtains a plurality of initial growth parameters and a plurality of parameter values of each initial growth parameter from the growth data, then the electronic device selects the maximum and minimum values of the plurality of parameter values and determines a parameter range of each initial growth parameter according to the maximum and minimum values, then the electronic device constructs the relationship between each initial physiological stage and each parameter range, thereby obtaining the state shunt model.

The plurality of initial growth parameters include, but are not limited to, a leaf area, the number of leaves, and a plant height.

In at least one embodiment, the electronic device constructs illumination regulation model by steps as follows.

The electronic device obtains a peak-valley electricity price time period of each day, which refers to an electricity price time period of each day by peaks and valleys in a graph of electricity consumption according to demand and the resulting prices. The peak-valley electricity price time period includes valley electricity price periods, flat electricity price periods, and peak electricity price periods. Then the electronic device counts duration of the valley electricity price periods as a first time and counts duration of the flat electricity price periods as a second time. If each initial illumination time is less than or equal to the first time, the electronic equipment selects a first start point and a first end point in the valley electricity price periods as the characteristic illumination time period. If each initial illumination time is greater than the first time and is less than or equal to a sum of the first time and the second time, the electronic device selects a second start point and a second end point in the flat electricity price periods as the first illumination time period, and determines the valley electricity price periods and the first illumination time period as the characteristic illumination time period. If each initial illumination time is greater than the sum of the first time and the second time, the electronic device selects a third start point and a third end point in the peak electricity price periods as the second illumination time period, and determines the valley electricity price periods, the flat electricity price periods, and the second illumination time period as the characteristic illumination time period. Then the electronic device constructs the relationship between each initial illumination time and each characteristic illumination time period. Thereby, the illumination regulation model is obtained.

The peak load periods refer to the time periods with the highest electricity price during the day and per day, the valley electricity price periods refer to the time periods with the lowest electricity price during the day and per day, and the flat electricity price periods refer to the time periods with the electricity price which is in between the high and the low prices.

For example, if any initial illumination time is 13 hours, the peak load periods in a location are 9:00-11:00, 14:00-19:00, and 19:00-21:00, the flat electricity price periods are 7:00-9:00, 11:00-14:00 and 21:00-24:00, and the valley load period is 0:00-7:00, where the first time corresponding to the valley load period is 7 hours, and the second time corresponding to the flat electricity price periods is 8 hours. The initial illumination time is greater than the first time and is less than the sum of the first time and the second time. Therefore, the first illumination time period is selected from the flat electricity price periods, and the valley electricity price periods and the first illumination time period are determined as the characteristic illumination time periods. Therefore, the characteristic illumination time periods can be 0:00-9:00, 11:00-14:00, and 21:00-22:00. The characteristic illumination time periods can also be 0:00-9:00, 11:00-12:00, and 21:00-24:00. The characteristic illumination time periods can also be 0:00-9:00, 11:00-14:00, 23:00-24:00. It is to be understood that the characteristic illumination time periods can be set as needed.

In the above embodiments, according to the comparison of each initial illumination time with the first time and the second time, the characteristic illumination time period corresponding to each initial illumination time can be flexibly selected according to a variation in price of electricity. Since the characteristic illumination time period corresponding to each initial illumination time is preferably selected from the valley electricity price periods, the illumination cost can be reduced on the premise that the target plant has sufficient illumination.

At block S13, the plurality of plant images are inputted into the growth calculation model to obtain a target growth parameter corresponding to each plant image.

In at least one embodiment, the target growth parameter refers to a parameter value of a plant characteristic of that target plant. For example, when the plant characteristic is a leaf, a corresponding target growth parameter can be a leaf area, and the target growth parameter can be used to determine the physiological stages of the target plant.

In at least one embodiment, the target growth parameter includes a leaf area, and the electronic device inputs the plurality of plant images into the growth calculation model to obtain the target growth parameter corresponding to each plant image by steps as follows.

The electronic device determines a position of each leaf in each plant image to obtain a target position. Then the electronic device performs feature extraction on each leaf according to the target position to obtain a target feature map. The electronic device detects a contour of each leaf in the target feature map to obtain a target contour. Then the electronic device calculates areas of all pixel points in the target contour to obtain the leaf area.

The target growth parameters further include number of leaves, plant height, etc.

In the above embodiments, the target growth parameters of the target plant can be extracted according to the growth calculation model.

When there are a number of target growth parameters, since the target growth parameters refer to the parameter values of plant characteristics of the target plant, the target growth parameters can accurately reflect the physiological state of the target plant.

At block S14, the target growth parameters are analyzed according to the state shunt model to obtain a first physiological stage of each plant image.

In at least one embodiment, the first physiological stage refers to the physiological stage of the target plant reflected by the target growth parameters, and the first physiological stage can be used to determine the growth state of the target plant.

In at least one embodiment, the electronic device analyzes the target growth parameters according to the state shunt model to obtain the first physiological stage of each plant image by steps as follows.

The electronic device compares the target growth parameter with the parameter range of each initial growth parameter in the state shunt model to obtain a parameter range of the target growth parameter. The electronic device determines the initial physiological stage corresponding to the parameter range of the target growth parameter as the first physiological stage.

In the above embodiment, by comparing the target growth parameter with the parameter range of each initial growth parameter, since the parameter range of each initial growth parameter in the state shunt model is in a one-to-one correspondence with each initial physiological stage, the physiological stage of the target plant can be determined quickly and accurately.

At block S15, a growth change value of the target plant is calculated according to a plurality of the target growth parameters.

In at least one embodiment, the growth change value refers to a difference between the target growth parameters corresponding to the generated time of the plurality of plant images in different time periods.

In at least one embodiment, the electronic device calculates the growth change value of the target plant according to the plurality of the target growth parameters by steps as follows.

The electronic device obtains the generated time of each plant image, marks the plurality of plant images according to the sequence of the generated times and obtains a plurality of marked images. Then the electronic device determines the target growth parameters of any two marked images with adjacent generated times as the first growth parameter and the second growth parameter, where the generated time of the second growth parameter is later than the generated time of the first growth parameter. If the numbers of the first and second growth parameters are more than one, the third growth parameter is selected from the first growth parameters based on a preset parameter priority, and the fourth growth parameter is selected from the second growth parameters based on the preset parameter priority. Then the electronic device subtracts the fourth growth parameter from the third growth parameter to obtain the growth change value.

The preset parameter priority can be set according to a difference between each first growth parameter and the corresponding second growth parameter. It should be noted that the larger the difference, the higher will be the preset parameter priority.

In the above embodiment, by setting the parameter priority, the third growth parameter can be filtered from the first growth parameter, the fourth growth parameter can be filtered from the second growth parameter, and the fourth parameter is subtracted from the third parameter. Because the number of calculated parameters are reduced, the operation of the growth change value is faster. In addition, the larger the difference is, the higher will be the priority of the preset parameter, so that the growth change value can more accurately reflect the growth change of the target plant.

At block S16, the first physiological stage is adjusted according to the growth change value to obtain the second physiological stage.

In at least one embodiment, the second physiological stage refers to the next physiological stage of the target plant after the first physiological stage.

In at least one embodiment, the electronic device adjusts the first physiological stage according to the growth change value to obtain the second physiological stage by steps as follows.

If the growth change value is less than a first preset value, the electronic device determines the growth change value as a growth retardation parameter and counts the number of growth retardation parameters. If the number is a second preset value, the electronic device determines the fourth growth parameter corresponding to the growth retardation parameter as a characteristic parameter. Then the electronic device adjusts the physiological stage of the marked image corresponding to the characteristic parameter from the first physiological stage to the second physiological stage.

The first preset value can be set by itself and is not limited. The second preset value may include, but is not limited to, 4, 5, and 6.

When the target plant is a lettuce plant and the first physiological stage is the seedling period, since the next physiological stage of the seedling period is the growing period, the second physiological stage can be the growing period.

In the above embodiments, the difference in growth which is less than the first preset value is determined as the growth retardation parameter. Because the growth change value can accurately reflect the growth change of the target plant, the growth retardation parameter can better reflect the growth retardation status of the target plant. The number of growth retardation parameters are counted, and a determination made as to adjusting the first physiological stage to the second physiological stage according to the comparison between the number and the second preset value, which can not only improve the timeliness of adjustment, but also improve the accuracy of adjustment.

At block S17, based on the target growth model, the target illumination time corresponding to the second physiological stage is generated.

In at least one embodiment, the target illumination time refers to the illumination time required by the target plant when it is in the second physiological stage.

In at least one embodiment, before generating a target time period according to the illumination regulation model and the target illumination time, the method further includes steps as follows.

The electronic device constructs a coordinate system based on the planting plane and determines the plants in the marked image corresponding to the second physiological stage as characteristic plants. Then the electronic device controls the transplanting device to transfer the characteristic plants to the illuminated environment corresponding to the target illumination time based on the positions of the characteristic plants in the coordinate system.

The coordinate origin of the coordinate system includes, but is not limited to, any position of the planting plane, such as the center or the edge angle position.

In other embodiments, the plants are planted in layers in the plant factory, that is, there are a plurality of layers of planting planes. There are a plurality of plants of the same species in each planting plane. In addition, different planting planes of the same species of plants correspond to different illumination times. The planting plane can be of any shape, for example, the planting plane can be rectangular.

Specifically, the electronic device controls the transplanting device to transfer the feature plant to the illuminated environment corresponding to the target illumination time based on the position of the feature plant in the coordinate system by steps as follows.

The electronic device constructs a three-dimensional coordinate system based on a plurality of layers of planting planes. For example, it is supposed that the electronic device determines the planting plane of the characteristic plant as the first planting plane, with the length of the first planting plane as the X axis, the width as the Y axis, and the height as the Z axis, and with the intersection of any two lines in the first planting plane as the coordinate origin. The electronic device takes the center point of the planting position of the characteristic plant as the initial coordinate of the characteristic plant, and determines the planting plane corresponding to the target illumination times as the second planting plane. The electronic device detects the blank position in the second planting plane, and takes the center point of any blank position as the target coordinate. The electronic device controls the transplanting device to move the characteristic plant from the initial coordinate to the target coordinate.

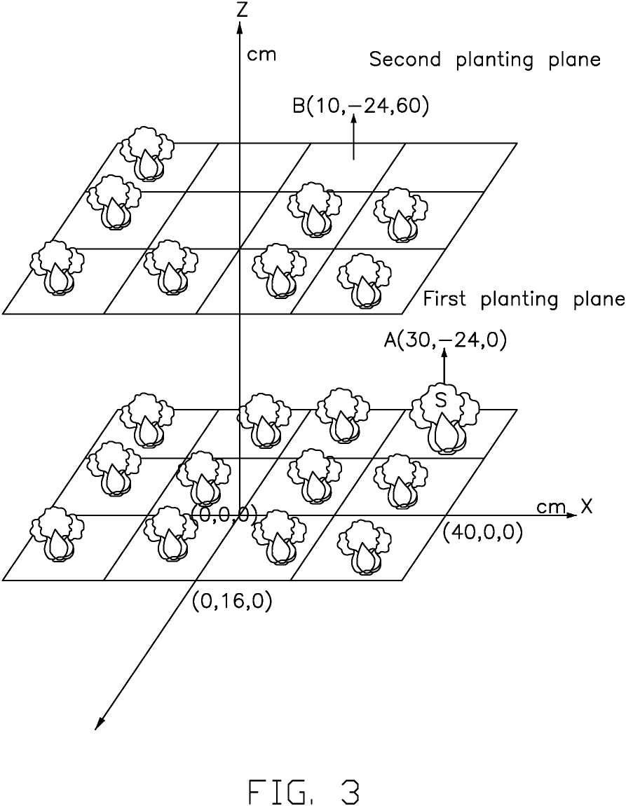

FIG. 3 is schematic diagram showing a coordinate system constructed in the method. A plurality of plants of the same species are distributed in the first planting plane, and plant S is the characteristic plant. It can be seen from FIG. 3 that plant S has larger leaf area, higher plant height, and larger plant volume than other plants, and the characteristic plant S should enter the illuminated environment corresponding to the target illumination time. When the planting plane of the characteristic plant S is rectangular, the electronic device determines the planting plane of the characteristic plant S as the first planting plane. The electronic device takes the length of the first planting plane as the X axis, the width as the Y axis, the height as the Z axis, and the intersection of any two lines in the first planting plane as the coordinate origin to construct a three-dimensional coordinate system. The electronic device takes the center point A of the planting position of the characteristic plant S as the initial coordinate, such as A (30, -24, 0). The electronic device takes the planting plane corresponding to the target illumination time as the second planting plane, detects the blank position in the second planting plane, and takes the center point B of any blank position as the target coordinate, such as B (10, -24, 60). Therefore, the electronic device can control the transplanting device to transfer the characteristic plant S from the initial coordinate to the target coordinate.

In the above embodiment, the position of the target plant in the coordinate system can be located, and then the target plant in the second physiological stage can be accurately transferred to the illuminated environment corresponding to the target illumination time, so as to avoid slow growth of the target plant due to insufficient illumination.

At block S18, a target time period according to the light regulation model and the target illumination time is generated.

In at least one embodiment, the duration of the characteristic illumination time period is the target illumination time.

In at least one embodiment, the electronic device generates a target time period according to the illumination adjustment model and the target illumination time by steps as follows.

The electronic device compares the target illumination time with each initial illumination hour in the illumination adjustment model to determine the initial illumination time corresponding to the target illumination time. Based on the relationship between each initial illumination hour and each characteristic illumination time period, the electronic device determines the characteristic illumination time period corresponding to the initial illumination time as the target time period.

In the above embodiment, since each initial illumination hour is in one-to-one correspondence with each characteristic illumination time period in the illumination adjustment model, the target time period can be quickly selected.

At block S19, the target time period is sent to the illumination device, and the illumination device is controlled to regulate the illumination of the target plant according to the target time period.

In at least one embodiment, the electronic device sends the target time period to the illumination device, and calculates the illumination cost corresponding to the target time period according to the preset electricity price.

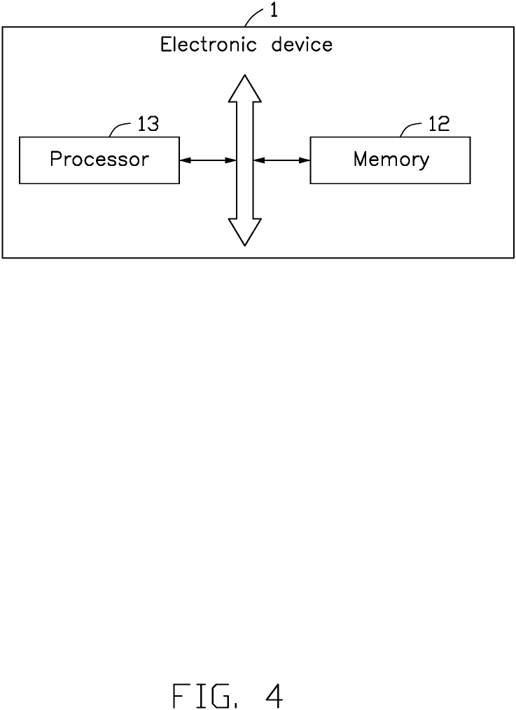

FIG. 4 is schematic diagram of an electronic device according to an embodiment. The electronic device 1 includes, but is not limited to, a memory 12, a processor 13, and a computer program stored in the memory 12 and operable on the processor 13, such as a program for regulating illumination of plants.

A person skilled in the art may understand that the schematic diagram is only an example of the electronic device 1 and does not constitute a limitation on the electronic device 1, and may include more or less components than the illustration, or have a combination of certain components, or different components, for example, the electronic device 1 may further include input and output devices, network access devices, buses, and the like.

The processor 13 may be a central processing unit, or other general-purpose processors, digital signal processors, application specific integrated circuits, Field-Programmable Gate Arrays, or other programmable logic device, discrete gate or transistor logic device, discrete hardware component, etc. The general-purpose processor may be a microprocessor or the processor 13 may also be any conventional processor, etc. The processor 13 is the computing core and control center of the electronic device 1, uses various interfaces and lines to connect various parts of the entire electronic device 1, and obtains the operating system of the electronic device 1 and various installed applications, program codes, etc. For example, the processor 13 can acquire the plurality of plant images captured by the imaging device 2 through an interface.

The processor 13 obtains the operating system of the electronic device 1 and various installed applications. The processor 13 obtains the application program to implement the steps in the above embodiments of the plant light regulation method, such as the steps shown in FIG. 2.

For example, the computer program can be divided into one or more modules / units, which are stored in the memory 12 and obtained by the processor 13 to complete the application. The one or more modules / units can be a series of computer program instruction segments that can complete specific functions, which are used to describe the acquisition process of the computer program in the electronic device 1.

The memory 12 can be used to store the computer program and/or module. The processor 13 executes the computer program and/or module stored in the memory 12 to implement various functions of the electronic device 1. The memory 12 can include a storage program area and a storage data area, wherein the storage program area can store an operating system, an application program required for at least one function (such as a sound playback function, an image playback function, etc.); the storage data area can store data created according to the use of electronic devices. In addition, the memory 12 may include nonvolatile memory, such as hard disk, memory, plug-in hard disk, smart media card (SMC), secure digital (SD) card, flash card, at least one disk storage device, flash memory device, or other nonvolatile solid-state storage devices.

The memory 12 may be an external memory and / or an internal memory of the electronic device 1. Further, the memory 12 may be a memory in physical form, such as a memory module, a TF card, and the like.

When the modules/units integrated into the electronic device 1 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

With reference to FIG. 1, the memory 12 in the electronic device 1 stores a plurality of instructions to implement the method for regulating illumination of plants, and the processor 13 can obtain the plurality of instructions to implement the following steps: obtaining a plurality of plant images of the target plant at different stages and obtaining the plant species of the target plant. The processor 13 constructes a target growth model according to the plant species, where the target growth model includes illumination time corresponding to different physiological stages. The processor 13 constructes a growth calculation model, a state shunt model, and an illumination regulation model. The processor 13 inputs the plurality of plant images into the growth calculation model to obtain the target growth parameters corresponding to each plant image. The processor 13 analyzes the target growth parameters according to the state shunt model to obtain the first physiological stage of each plant image. The processor 13 calculates the growth change value of the target plant according to a plurality of the target growth parameters. The processor 13 adjusts the first physiological stage according to the growth change value to obtain the second physiological stage. The processor 13 generates the target illumination time corresponding to the second physiological stage based on the target growth model. The processor 13 generates a target time period according to the illumination regulation model and the target illumination time. The processor 13 sends the target time period to the illumination device, and controls the illumination device to adjust the illumination of the target plant according to the target time period.

Specifically, for specific implementation of above-mentioned instructions by the processor 13, reference can be made to the description of relevant steps in the embodiments corresponding to FIG. 2, which will not be repeated here.

In the several embodiments provided by the present embodiments, it should be understood that the disclosed system, apparatus, and method may be implemented in other manner. For example, the device embodiments described above are merely illustrative. For example, the division of the modules is only a logical function division, the actual implementation may have other manner of division.

The modules described as separate components may or may not be physically separated, and the components displayed as modules may or may not be physical modules, that is, may be located in one place, or may be distributed in multiple network modules. Some or all of the modules may be selected according to actual needs to achieve the purpose of the method.

In addition, each functional module in each embodiment of the present embodiments may be integrated into one processing unit, or each unit may exist as a standalone unit, or two or more modules may be integrated into one unit. The above integrated unit can be implemented in the form of hardware or in the form of hardware plus software function modules.

In addition, each functional module in each embodiment of the present embodiments may be integrated into one processing unit, or each unit may exist as a standalone unit, or two or more modules may be integrated into one unit. The above integrated unit can be implemented in the form of hardware or in the form of hardware plus software function modules.

It should be noted that the above embodiments are only for explaining the technical solutions of the present embodiments and are not intended to be limiting, and the present embodiments describes preferred embodiments. Modifications or equivalents can be made or used without departing from the spirit and scope of the present embodiments.

What is claimed is:

1. A method for regulating illumination of plants, applied to an electronic device, the method comprising:
obtaining a plurality of plant images of a target plant at different time periods and a plant species of the target plant;
constructing a target growth model according to the plant species, wherein the target growth model includes illumination times corresponding to different physiological stages;
constructing a growth calculation model, constructing a state shunt model, constructing an illumination regulation model;
inputting the plurality of plant images into the growth calculation model to obtain a target growth parameter corresponding to each of the plurality of plant images;
analyzing the target growth parameter according to the state shunt model to obtain a first physiological stage of each of the plurality of plant images;
calculating a growth change value of the target plant according to a plurality of the target growth parameter;
adjusting the first physiological stage according to the growth change value to obtain a second physiological stage;
generating a target illumination time corresponding to the second physiological stage based on the target growth model;
generating a target time period according to the light regulation model and the target illumination time; and
sending the target time period to an illumination device, controlling the illumination device to regulate illumination of the target plant according to the target time period.

2. The method of claim 1, wherein the constructing a target growth model according to the plant species comprises:
obtaining growth data of the target plant from a preset database according to the plant species, the growth data comprising a plurality of initial physiological stages and a plurality of initial illumination times;
constructing a relationship between each of the plurality of initial physiological stages and each of the plurality of initial illumination times.

3. The method of claim 2, wherein the growth data further comprises a plurality of initial growth parameters and a plurality of parameter values of each of the plurality of initial growth parameters, the constructing a state shut model comprises:
selecting maximum and minimum values of the plurality of parameter values;
determining a parameter range of each of the plurality of initial growth parameters according to the maximum and minimum values;
constructing a relationship between each of the plurality of initial physiological stage and each parameter range.

4. The method of claim 2, wherein the constructing an illumination regulation model comprises:
obtaining a peak-valley electricity price time period of each day, wherein the peak-valley electricity price period comprises at least one valley electricity price period, at least one flat electricity price period, and at least one peak electricity price period;
counting duration of the at least one valley electricity price period as a first time, counting duration of the at least one flat electricity price period as a second time;
if each of the plurality of initial illumination times is less than or equal to the first time, selecting a first start point and a first end point in the at least one valley electricity price period as a characteristic illumination time period; or
if each of the plurality of initial illumination times is greater than the first time and is less than or equal to a sum of the first time and the second time, selecting a second start point and a second end point in the at least one flat electricity price period as a first illumination time period, and determining the at least one valley electricity price period and the first illumination time period as the characteristic illumination time period; or
if each of the plurality of initial illumination times is greater than the sum of the first time and the second time, selecting a third start point and a third end point in the at least one peak electricity price period as a second illumination time period, and determining the at least one valley electricity price period, the at least one flat electricity price period, and the second illumination time period as the characteristic illumination time period;
constructing a relationship between each of the plurality of initial illumination times and each characteristic illumination time period.

5. The method of claim 1, wherein the target growth parameter comprises a leaf area, the inputting the plurality of plant images into the growth calculation model to obtain a target growth parameter corresponding to each of the plurality of plant images comprises:
determining a position of each leaf in each of the plurality of plant images to obtain a target position;
performing feature extraction on each leaf according to the target position to obtain a target feature map;
detecting a contour of each leaf in the target feature map to obtain a target contour; and
calculating areas of all pixel points in the target contour to obtain the leaf area.

6. The method of claim 1, wherein calculating a growth change value of the target plant according to a plurality of the target growth parameter comprises:
obtaining generated time of each of the plurality of plant images;
marking the plurality of plant images according to the sequence of generated times to obtain a plurality of marked images;
determining target growth parameters of any two marked images with adjacent generated times as a first growth parameter and a second growth parameter, the generated time of the second growth parameter being greater than the generated time of the first growth parameter;
if the number of the first growth parameter is a plurality and the number of the second growth parameter is a plurality, selecting a third growth parameter from the plurality of first growth parameters based on a preset parameter priority, and selecting a fourth growth parameter from the plurality of second growth parameters based on the preset parameter priority;
subtracting the fourth growth parameter from the third growth parameter to obtain the growth change value.

7. The method of claim 6, wherein the adjusting the first physiological stage according to the growth change value to obtain a second physiological stage comprises:
if the growth change value is less than a first preset value, determining the growth change value as a growth retardation parameter;
counting the number of a plurality of the growth retardation parameter;
if the number of the plurality of growth retardation parameters is a second preset value, determining the fourth growth parameter corresponding to the plurality of growth retardation parameters as a characteristic parameter;
adjusting a physiological stage of one marked image corresponding to the characteristic parameter from the first physiological stage to the second physiological stage_{∘}
.

8. The method of claim 7, wherein before the adjusting the first physiological stage according to the growth change value to obtain a second physiological stage, the method further comprises:
constructing a coordinate system based on a planting plane,
determining a plant in one marked image corresponding to the second physiological stage as a characteristic plant;
controlling a transplanting device to transfer the characteristic plant to an illuminated environment corresponding to the target illumination time based on a position of the characteristic plant in the coordinate system.

9. An electronic device comprising:
a processor; and
a memory storing a plurality of instructions, which when executed by the processor, causes the processor to:
obtain a plurality of plant images of a target plant at different time periods and a plant species of the target plant;
construct a target growth model according to the plant species, wherein the target growth model includes illumination times corresponding to different physiological stages;
construct a growth calculation model, construct a state shunt model, construct an illumination regulation model;
input the plurality of plant images into the growth calculation model to obtain a target growth parameter corresponding to each of the plurality of plant images;
analyze the target growth parameter according to the state shunt model to obtain a first physiological stage of each of the plurality of plant images;
calculate a growth change value of the target plant according to a plurality of the target growth parameter;
adjust the first physiological stage according to the growth change value to obtain a second physiological stage;
generate a target illumination time corresponding to the second physiological stage based on the target growth model;
generate a target time period according to the light regulation model and the target illumination time; and
send the target time period to an illumination device, controlling the illumination device to regulate illumination of the target plant according to the target time period.

10. The electronic device of claim 9, wherein the processor is further caused to:
obtain growth data of the target plant from a preset database according to the plant species, the growth data comprising a plurality of initial physiological stages and a plurality of initial illumination times;
construct a relationship between each of the plurality of initial physiological stages and each of the plurality of initial illumination times.

11. The electronic device of claim 10, wherein the processor is further caused to:
select maximum and minimum values of the plurality of parameter values;
determine a parameter range of each of the plurality of initial growth parameters according to the maximum and minimum values;
construct a relationship between each of the plurality of initial physiological stage and each parameter range.

12. The electronic device of claim 10, wherein the processor is further caused to:
obtains a peak valley electricity price period of each day, wherein the peak valley electricity price period comprises at least one valley electricity price period, at least one flat electricity price period, and at least one peak electricity price period;
count duration of the at least one valley electricity price period as a first time, counting duration of the at least one flat electricity price period as a second time;
if each of the plurality of initial illumination times is less than or equal to the first time, select a first start point and a first end point in the at least one valley electricity price period as a characteristic illumination time period; or
if each of the plurality of initial illumination times is greater than the first time and is less than or equal to a sum of the first time and the second time, select a second start point and a second end point in the at least one flat electricity price period as a first illumination time period, and determine the at least one valley electricity price period and the first illumination time period as the characteristic illumination time period; or
if each of the plurality of initial illumination times is greater than the sum of the first time and the second time, select a third start point and a third end point in the at least one peak electricity price period as a second illumination time period, and determine the at least one valley electricity price period, the at least one flat electricity price period, and the second illumination time period as the characteristic illumination time period;
construct a relationship between each of the plurality of initial illumination times and each characteristic illumination time period.

13. The electronic device of claim 9, wherein the processor is further caused to:
determine a position of each leaf in each of the plurality of plant images to obtain a target position;
perform feature extraction on each leaf according to the target position to obtain a target feature map;
detect a contour of each leaf in the target feature map to obtain a target contour; and
calculate areas of all pixel points in the target contour to obtain the leaf area.

14. The electronic device of claim 9, wherein the processor is further caused to:
obtain generated time of each of the plurality of plant image;
mark the plurality of plant images according to the sequence of the generated times to obtain a plurality of marked images;
determine target growth parameters of any two marked images with adjacent generated times as a first growth parameter and a second growth parameter, the generated time of the second growth parameter being greater than the generated time of the first growth parameter;
if the number of the first growth parameter is a plurality and the number of the second growth parameter is a plurality, select a third growth parameter from the plurality of first growth parameters based on a preset parameter priority, and select a fourth growth parameter from the plurality of second growth parameters based on the preset parameter priority;
subtract the fourth growth parameter from the third growth parameter to obtain the growth change value.

15. The electronic device of claim 14, wherein the processor is further caused to:
if the growth change value is less than a first preset value, determine the growth change value as a growth retardation parameter;
count the number of a plurality of the growth retardation parameter;
if the number of the plurality of growth retardation parameters is a second preset value, determine the fourth growth parameter corresponding to the plurality of growth retardation parameters as a characteristic parameter;
adjust a physiological stage of one marked image corresponding to the characteristic parameter from the first physiological stage to the second physiological stage_{∘}
.

16. The electronic device of claim 15, wherein the processor is further caused to:
construct a coordinate system based on a planting plane, determine a plant in one marked image corresponding to the second physiological stage as a characteristic plant;
control a transplanting device to transfer the characteristic plant to an illuminated environment corresponding to the target illumination time based on a position of the characteristic plant in the coordinate system.

17. A non-transitory readable medium having stored thereon instructions that, when executed by a processor of an electronic device, causes the processor of the electronic device to perform a method for regulating illumination of plants, the method comprising:
obtaining a plurality of plant images of a target plant at different time periods and a plant species of the target plant;
constructing a target growth model according to the plant species, wherein the target growth model includes illumination times corresponding to different physiological stages;
constructing a growth calculation model, constructing a state shunt model, constructing an illumination regulation model;
inputting the plurality of plant images into the growth calculation model to obtain a target growth parameter corresponding to each of the plurality of plant images;
analyzing the target growth parameter according to the state shunt model to obtain a first physiological stage of each of the plurality of plant images;
calculating a growth change value of the target plant according to a plurality of the target growth parameter;
adjusting the first physiological stage according to the growth change value to obtain a second physiological stage;
generating a target illumination time corresponding to the second physiological stage based on the target growth model;
generating a target time period according to the light regulation model and the target illumination time; and
sending the target time period to an illumination device, controlling the illumination device to regulate illumination of the target plant according to the target time period.

18. The non-transitory readable medium of claim 17, wherein the constructing a target growth model according to the plant species comprises:
obtaining growth data of the target plant from a preset database according to the plant species, the growth data comprising a plurality of initial physiological stages and a plurality of initial illumination times;
constructing a relationship between each of the plurality of initial physiological stages and each of the plurality of initial illumination times.

19. The non-transitory readable medium of claim 18, wherein the growth data further comprises a plurality of initial growth parameters and a plurality of parameter values of each of the plurality of initial growth parameters, the constructing a state shut model comprises:
selecting maximum and minimum values of the plurality of parameter values;
determining a parameter range of each of the plurality of initial growth parameters according to the maximum and minimum values;
constructing a relationship between each of the plurality of initial physiological stage and each parameter range.

20. The non-transitory readable medium of claim 18, wherein the constructing an illumination regulation model comprises:
obtaining a peak valley electricity price period of each day, wherein the peak valley electricity price period comprises at least one valley electricity price period, at least one flat electricity price period, and at least one peak electricity price period;
counting duration of the at least one valley electricity price period as a first time, counting duration of the at least one flat electricity price period as a second time;
if each of the plurality of initial illumination times is less than or equal to the first time, selecting a first start point and a first end point in the at least one valley electricity price period as a characteristic illumination time period; or
if each of the plurality of initial illumination times is greater than the first time and is less than or equal to a sum of the first time and the second time, selecting a second start point and a second end point in the at least one flat electricity price period as a first illumination time period, and determining the at least one valley electricity price period and the first illumination time period as the characteristic illumination time period; or
if each of the plurality of initial illumination times is greater than the sum of the first time and the second time, selecting a third start point and a third end point in the at least one peak electricity price period as a second illumination time period, and determining the at least one valley electricity price period, the at least one flat electricity price period, and the second illumination time period as the characteristic illumination time period;
constructing a relationship between each of the plurality of initial illumination times and each characteristic illumination time period.
